(19) United States
(12) Patent Application Publication
(10) Pub. No.: US 2013/0031834 A1
(43) Pub. Date: Feb. 7, 2013

(54) VERTICAL PLANTER SYSTEM FOR ORCHIDS AND EPIPHYTIC PLANTS

(71) Applicant: Rafael Mosca, San Antonio de los Altos (VE)

(72) Inventor: Rafael Mosca, San Antonio de los Altos (VE)

(21) Appl. No.: 13/195,272

(22) Filed: Aug. 1, 2011

(51) Int. Cl. A01G 9/02

(52) U.S. Cl. 47/66.7; 47/79

(57) ABSTRACT

A vertical planter system for exposing the roots of orchids and other epiphytic plants to the open air, includes a support structure having a frame with a base end for housing a humidifying tray and a top end for housing an irrigation tray. The planter system further includes a support member for mounting a growing medium. The irrigation tray includes small holes such that when water is introduced into the tray, the water passes through the holes to mimic natural rainfall and allow the water to trickle from the tray to the epiphytic plant and roots, thereby avoiding the rotting of plant roots that occurs from over watering when plant roots are concealed in plant containers and pots.

### BACKGROUND OF THE INVENTION

1. Field of the Invention

The present disclosure relates generally to a method and apparatus for the maintenance of orchids and other epiphytic plants and more particularly to a mounting system that dispenses with a traditional container or pot and allows airflow to prevent plant infection, the system further including irrigation and humidifying means to promote plant health and growth.

2. Description of the Related Art

It is known in the art that epiphytic plants such as orchids prosper in the most natural growing conditions. Epiphytic plants derive moisture for their development from the open air.

Epiphytic plants are typically grown in pots. The pots include a well drained growing medium. Growing epiphytic plants in pots however fails to simulate the natural growing conditions conducive to prosperous growth, where the roots are exposed and free to grow and benefit from maximum drainage.

U.S. Pat. No. 2,956,370 (to Wieboldt) discloses an orchid cultivation device and method of cultivating orchids which includes a container having a transparent body, with a closed bottom and drainage means. Wieboldt further claims a structure in which the container comprises a flexible impervious sack.

U.S. Pat. No. 5,555,676 (to Lund) teaches a vertical planter for supporting a plurality of plants in a vertical manner. The planter of Lund includes a hollow column mounted vertically on a water reservoir. The hollow is comprised of one or more column modules filled with a planting medium.

An orchid cultivating device is discussed in U.S. Pat. No. 6,098,337 (to Chen et al.). The device includes a flat base plate, guard members, retainer rods and clamps.

Janowak et al. teaches a support structure for hanging plants in U.S. Pat. No. 7,770,743. The support structure of Janowak also includes a plurality of frames, rods, clamps and mounting members.

U.S. Patent Publication No. 2003/0150394 to Wolfe discloses a self contained tropical rainforest vivarium system for creating and maintaining environmental conditions found in a natural tropical rainforest habitat.

A vertical garden panel for supporting living plants on a vertical surface having a fabric folded into one or more vertically arranged knife pleats is taught by U.S. Patent Publication No. 2011/0059518 (to Bribach et al.)

There is a need for an improved method and apparatus to foster the growth of epiphytic plants and in particular orchids in a natural environment that eliminates the use of a pot or container and allows the roots to be exposed and free to grow and benefit from maximum drainage.

### SUMMARY OF THE INVENTION

As described herein, the various exemplary embodiments of the present invention overcome one or more disadvantages known in the art.

In accordance with the present invention a vertical planter apparatus and method for orchids and other epiphytic plants is provided. The apparatus of the present invention may be constructed from wood, plastic, metal or a combination thereof. The particular composition of the material comprising the vertical planter apparatus does not define the present invention.

In one aspect of the present disclosure, a mounting system including a growing medium is provided. The growing medium may consist of compressed coconut, tree fern, cork, logs or other suitable growing medium. The plant, including the growing plant roots, is mounted and secured to the growing medium, in a manner that allows the plant to remain vertical and the plant roots to be exposed to the environment. The plant may be secured by any reasonable means.

In a preferred embodiment, the plant and exposed roots are secured to the growing medium using a cord. The vertical planter apparatus and method of the present invention allows air to flow readily through the plant roots. Carbon dioxide movement is not restricted as when the orchids and other epiphytic plants are maintained in a potted environment. The vertical planter apparatus and method of the present invention thereby prevents bacteria and fungi from encroaching on the plant roots.

According to another aspect of the disclosure, the vertical planter apparatus includes an irrigation system that mimics a light rainfall or sprinkle. In a preferred embodiment, the irrigation system consists of a tray with numerous holes, to replicate a dripping system, positioned at the bottom of the tray. The holes are preferably sized to match the tip of the head of a typical sewing needle. The particular configuration and size of the tray may vary without departing from the scope of the invention.

In yet another aspect of the invention, the tray of the irrigation system of the present invention is positioned above the growing medium and the width and length of the tray of the irrigation system is dimensioned to coordinate with the width and length of the growing medium, such that when water drips from the tray it encounters the growing medium. It is appreciated that the distance between the tray and growing medium may vary without departing from the scope of the invention.

The growing medium absorbs and retains moisture as water drips onto the medium from the irrigation tray. Moisture from the growing medium is absorbed by the roots, while excess water drains off the growing medium and is captured by a humidity tray positioned below the growing medium.

The humidity tray should be at least as wide and as long as that of the growing medium in order to collect excess water as it drains from the growing medium. In addition to collecting the excess water, the humidity tray will create a humid environment at the bottom of the vertical planter system, at a point proximate to the exposed plant roots. This system replicates the outdoor natural environment in which orchids and other epiphytic plants typically flourish.

In a further aspect of the present invention, the structural design of the vertical planter of the present invention imparts a novel and attractive means of cultivating plant life and nourishing the vital root system of plants.

It is an object of the present invention to provide a vertical planter system and method that replicates the natural habitat of orchids and other epiphytic plants that can be utilized in an indoor setting. The present invention may also be utilized in certain controlled outdoor settings.

An advantage of the present invention is that it will prevent the over watering of plants which often leads to the rotting of the root system and the eventual demise of the plant.

These and other aspects and advantages of the present disclosure will become apparent from the following detailed description of preferred embodiments of the invention considered in conjunction with the accompanying drawings, in which like drawings represent like components. It is to be understood, however, that the drawings are designed solely for purposes of illustration and not as a definition of the limits of the disclosure, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a side perspective view of the apparatus of the present invention being used to support and grow an orchid.

FIG. 2 is a top perspective view of the present invention in use with an orchid.

FIG. 3 is a perspective view of the irrigation tray of the present invention.

FIG. 4 is a front view of the apparatus of the present invention.

FIG. 5 is a rear view of the apparatus of the present invention.

FIG. 6 is a side perspective view of the apparatus of the present invention being used to support and grow an orchid.

FIG. 7 is an alternative embodiment of the supporting structure of the present invention.

FIG. 8 is another alternative embodiment of the supporting structure of the present invention.

FIG. 9 is yet another alternative embodiment of the supporting structure of the present invention.

FIG. 10 is another alternative embodiment of the supporting structure of the present invention.

### DETAILED DESCRIPTION OF THE DRAWINGS

The present invention is a method and apparatus for the maintenance of orchids and other epiphytic plants. The apparatus of the present invention is a mounting system that dispenses with a traditional container or pot and allows airflow to circulate more freely through the roots, thereby aiding in the prevention of plant infection. The vertical planter system of the present invention further includes irrigation and humidifying means to promote plant health and growth.

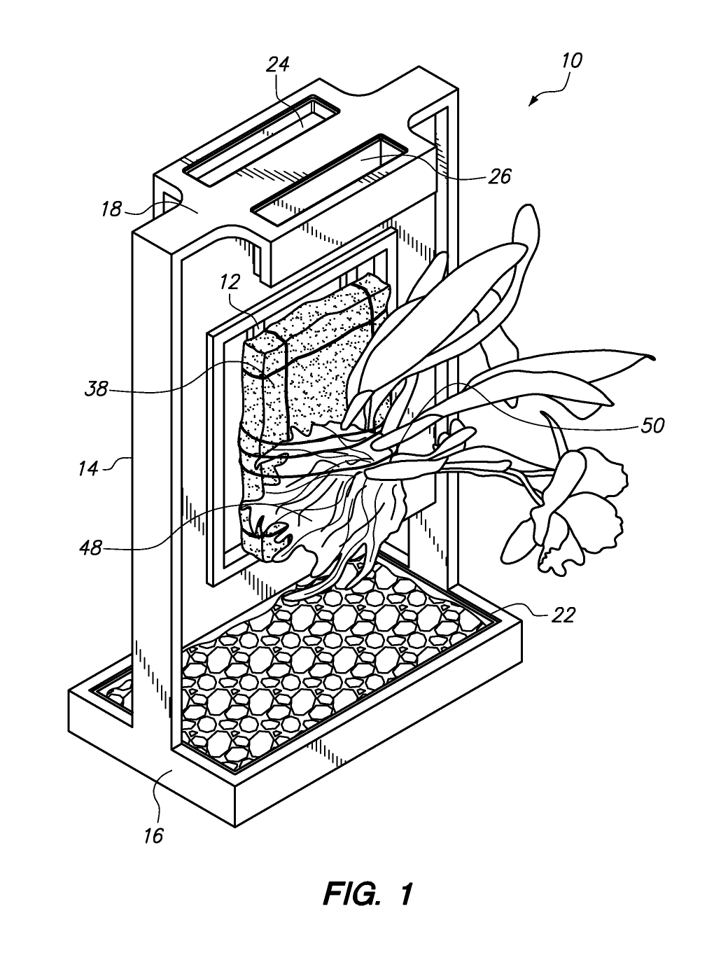

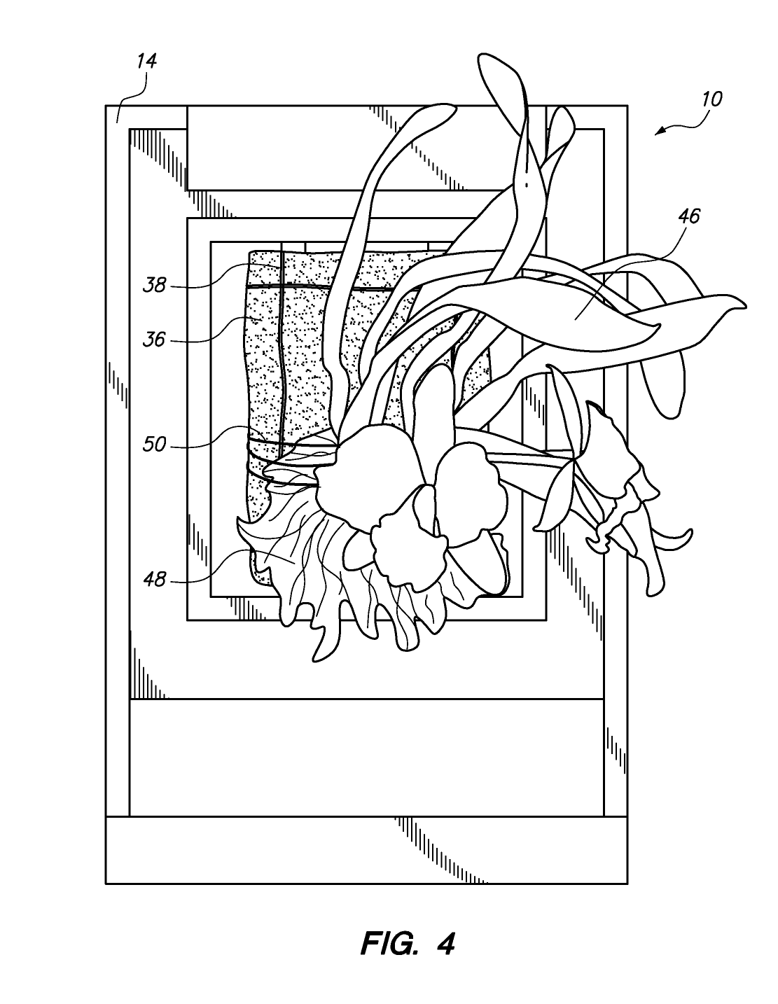

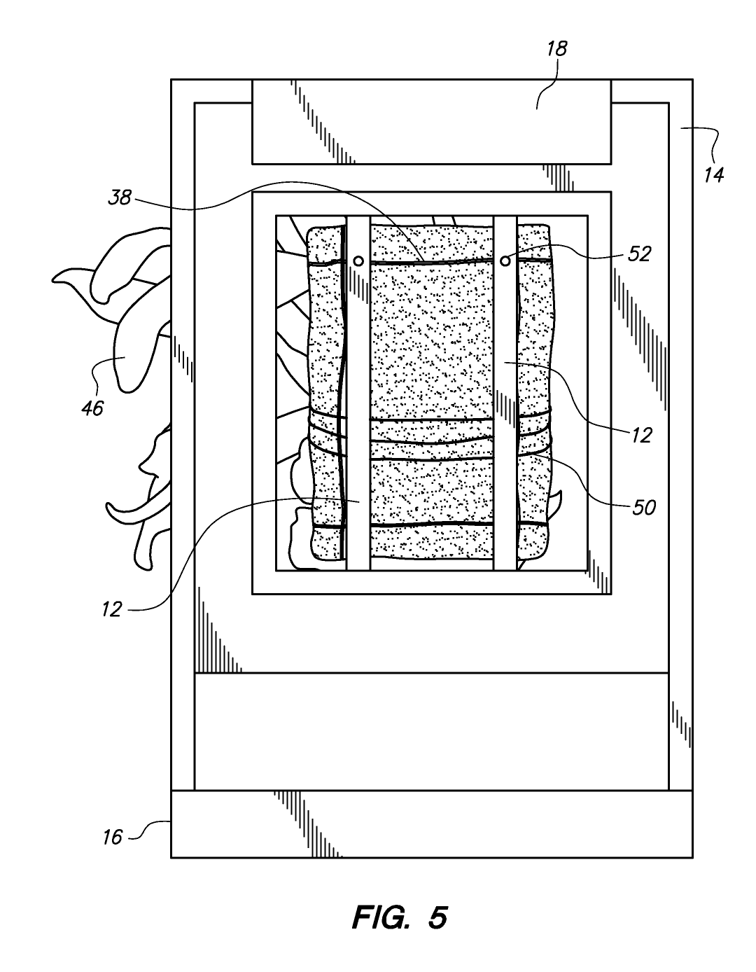

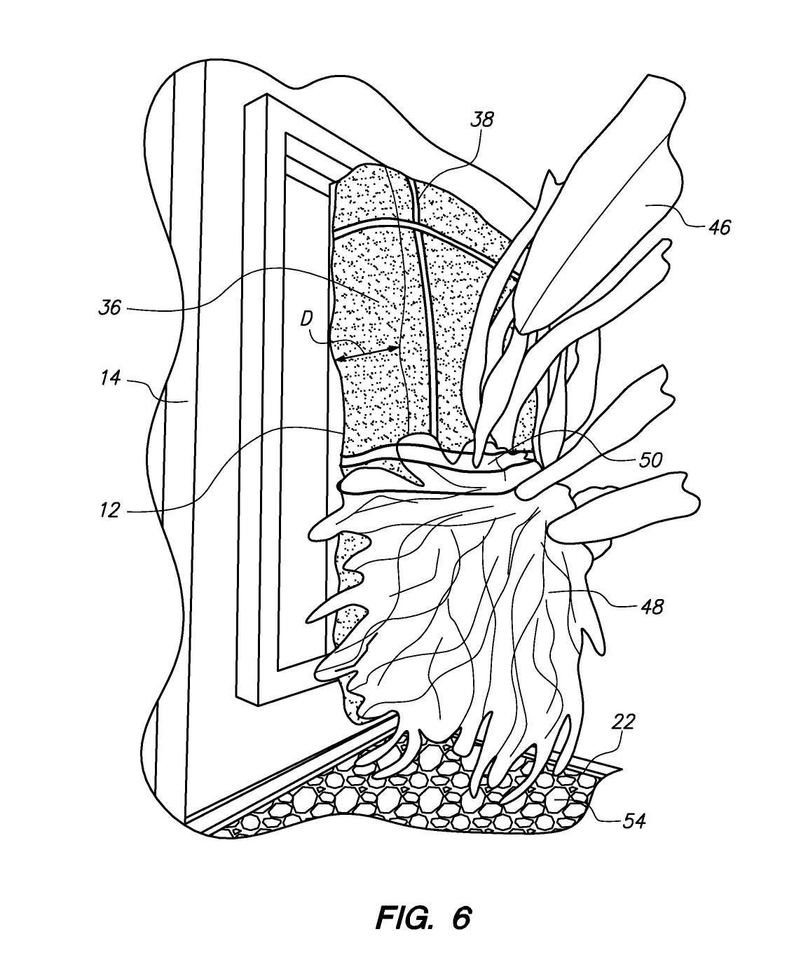

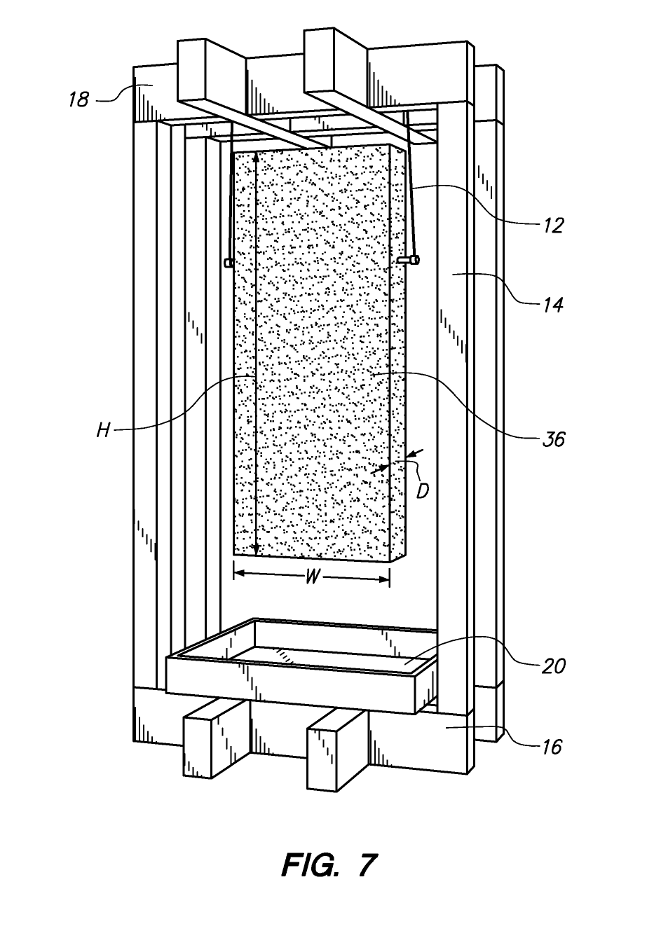

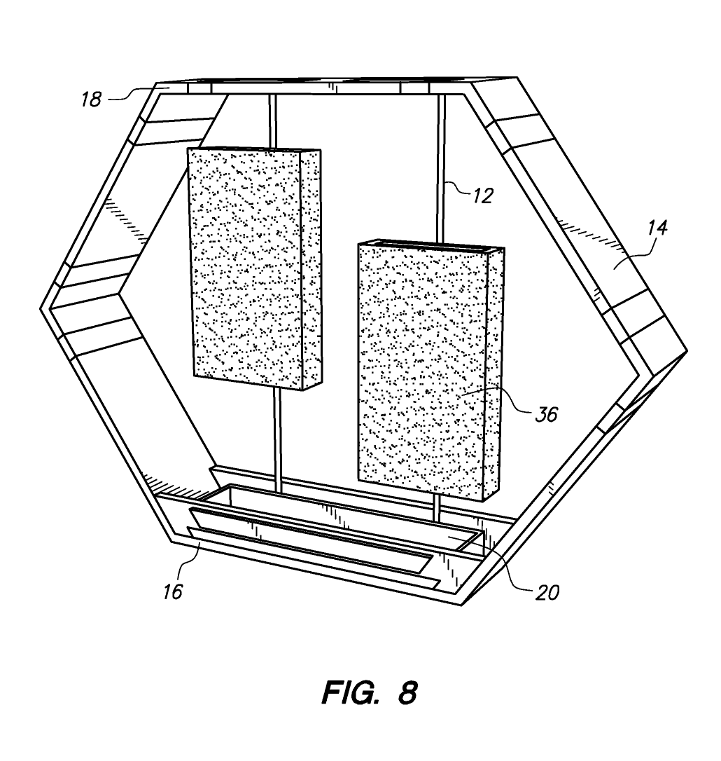

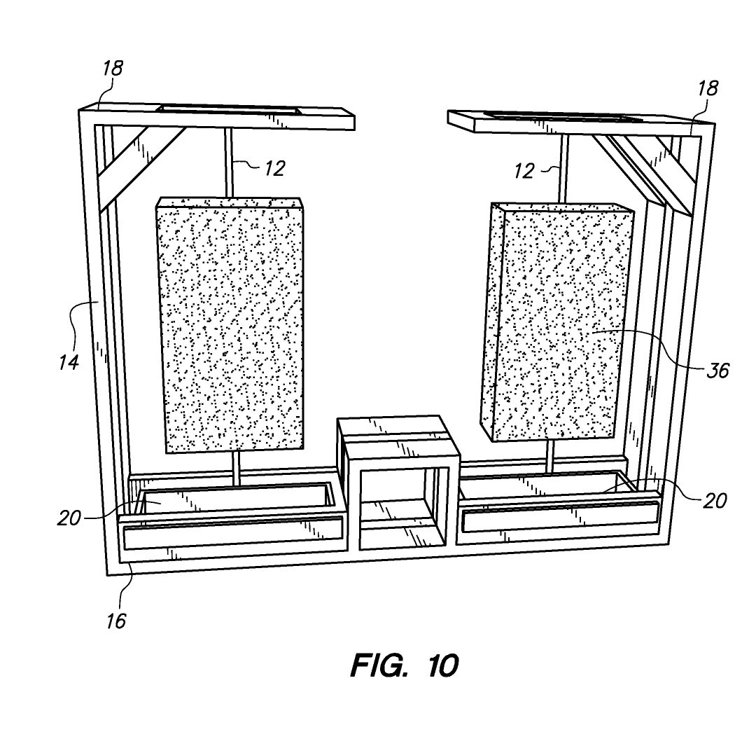

As illustrated in FIGS. 1-10. The vertical planter system 10 includes a support structure having a frame 14. The frame 14 further includes at least one support member 12, a base 16, and a top end 18 positioned distal to the base 16. The base 16 of the frame 14 defines a generally flat and shallow cavity 20 for housing a humidifying tray 22. The top end 18 of the frame 14 includes an elongated cavity 24 for housing an irrigation means 26.

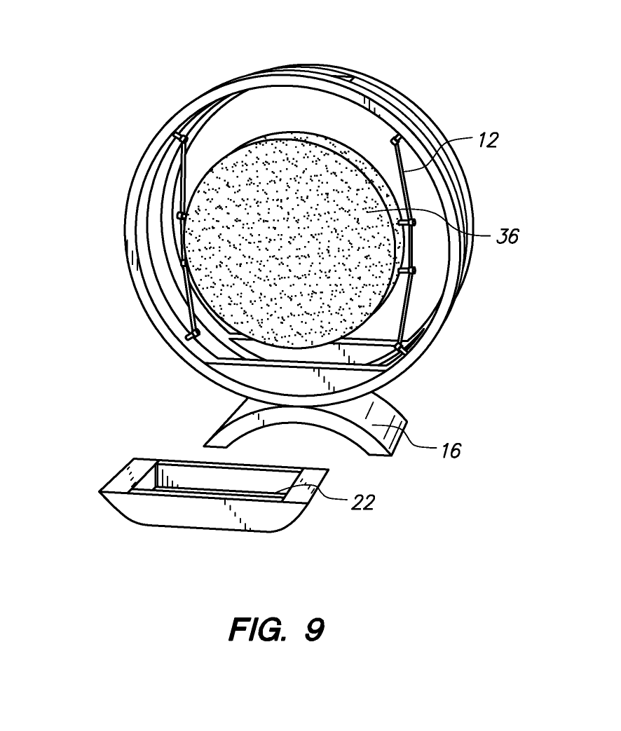

The vertical planter system 10 further includes a growing medium 36 mounted to the at least one support member 12. The growing medium 36 is densely packed and pre-shaped in a solid geometric form. In a preferred embodiment, the growing medium 36 is rectangular in shape. The growing medium may also be circular (as shown in FIG. 8) or any other geometric shape. The size of the growing medium 36 may vary according to the size of the frame 14. In one embodiment the growing medium 36 has a depth, defined as D in a preferred range of 1.5 to 2 inches and a height defined as H in a preferred range of 6 to 8 inches with the width defined as W in a preferred range of 5 to 6 inches.

The growing medium 36 should exhibit certain characteristics, namely, the ability to retain or hold water, the ability to hold nutrients and the ability to allow the roots of the plant a surface on which to cling to. Thus, in a preferred embodiment, the growing medium 36 may be composed of compressed coconut fiber, cork or tree fern. It is within the scope of the invention that the growing medium 36 may be composed of other material and that there exist a number of other types of viable growing medium 36 conducive to plant growth.

Referring to FIGS. 1, 4 and 6 there is shown an orchid 46 mounted to the growing medium 36. A chord 38 is also used to securely fasten a portion of the plant 46 and plant roots 48 to the growing medium 36, thereby allowing a portion of the roots 48 to at once cling to the medium 36 whilst allowing the roots 48 to remain predominantly exposed to the air, outside of a potted or contained environment.

Referring to FIGS. 1, 4, 5 and 6, the chord 38 secures the orchid 46 and roots 48 to the growing medium 36. In a preferred embodiment, the chord 38 secures a portion of the orchid 46 to the growing medium 36 by wrapping the chord 38 around a portion of the plant 46 and the growing medium 36. As is shown, the chord 38 may be wrapped around the growing medium 36 two or more times to securely affix the orchid 46 to the growing medium 36.

In addition, a portion of the roots 48 is secured to the growing medium 36 by the chord 38 around a portion of the roots 48 and growing medium 36. As is shown, the chord 38 may be wrapped around the growing medium 36 two or more times to achieve a secure mating arrangement between the roots 48 and growing medium 36.

As can be readily appreciated the position of the chord 38 relative to the orchid 46, roots 48 and growing medium 36 may vary depending on the size, type and condition of the orchid 46 and size and shape of the growing medium 36.

As is shown in FIG. 5 the growing medium 36 is secured to the at least one support member 12 using one or more tacks 52. As will be readily appreciated by one skilled in the art, the growing medium 36, may be secured to the support member 12 by any reasonable means, including clamps, thumb nails, or the like.

FIGS. 1-3, show an irrigation tray 26 positioned above the growing medium 36. The irrigation tray 26 of the present invention preferably mimics a light rainfall or sprinkle In a preferred embodiment, the irrigation tray 26 includes an elongated receptacle, with a height defined as H′, a depth defined as D′ and a width defined as W′. The bottom surface of the tray 26 includes numerous holes 28. The holes 28 are small, preferably sized to match the tip of the head of a typical sewing needle. The particular configuration and size of the tray 26 may vary without departing from the scope of the invention.

The depth D′, and width W′ of the tray 26 are preferably dimensioned to harmonize with the depth D and width W of the growing medium 36, such that when water is introduced from a water source, the water drips through the holes 28 at the bottom of the tray 26 the water encounters the growing medium 36 and surrounding portions of the orchid 46 and root system 48. It is appreciated that the distance between the tray 26 and growing medium 36 may vary without departing from the scope of the invention.

The purpose of the irrigation tray 26 is to permit a light sprinkling or dripping of water, thereby conserving water and limiting evaporation losses. The irrigation tray 26 may be comprised of clay, plastic, metal or other suitable material as will be appreciated by one reasonably skilled in the art.

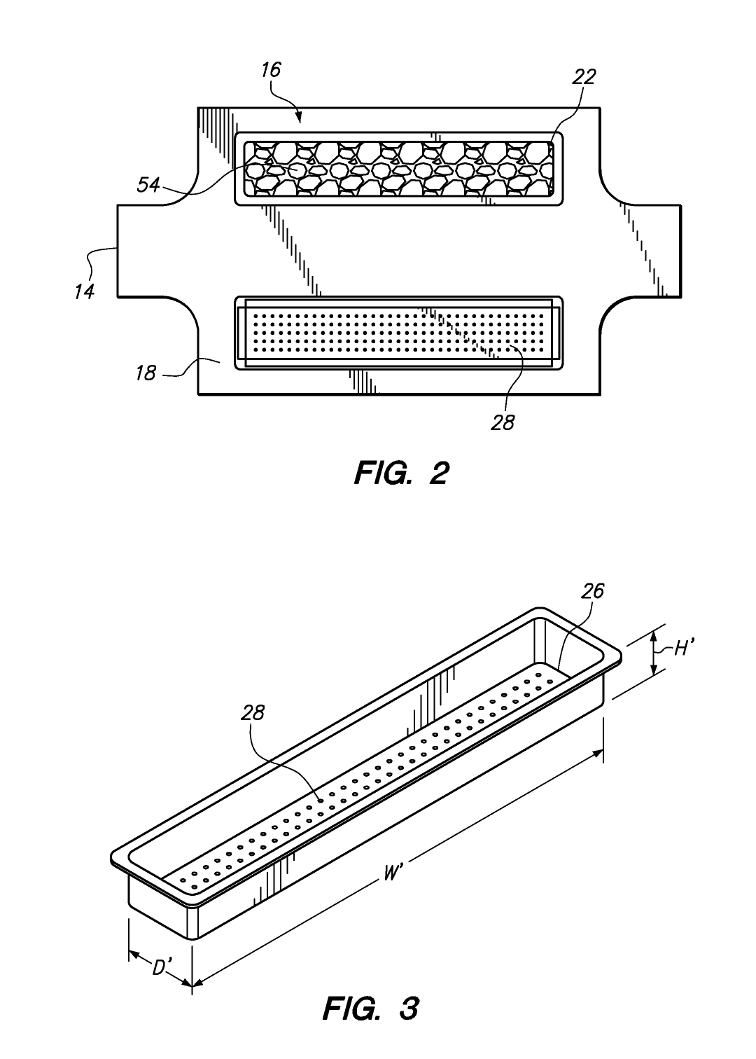

As shown in FIGS. 1-2, the irrigation tray 26 is nestled within a cavity 24 positioned at the top end 18 of the frame 14 of the present invention. The cavity 24 is situated above the growing medium 36.

As shown in FIGS. 1-3, 6-8, 10, a humidity tray 22 is housed within a cavity 20 at the base 16 of the frame 14. The humidity tray 22 should be at least as wide, W, and as deep, D, as that of the growing medium 36 in order to collect excess water as it drains from the growing medium 36.

In addition to collecting the excess water, the humidity tray 22 will create a humid environment at the base 16 of the vertical planter system 10, at a point proximate to the exposed plant roots 48. The humidity tray 22 includes rocks 54 that cover the bottom surface of the tray 22. The rocks 54 provide an evaporative surface area.

When the bottom surface of the tray 22 is covered with rocks 54, the rocks 54 stick up above the water level, thereby increasing the total surface area from which water evaporates. Water is pulled upward by capillary action to wet the entire exposed surface of the rocks 54. In addition to providing an evaporative surface area, the rocks 54 are aesthetically pleasing. It will be appreciated by one reasonably skilled in the art, that the humidity tray 22 may include pebbles, stones, marbles or the like. Thus, this system replicates the outdoor natural environment in which orchids and other epiphytic plants typically thrive.

Thus, when water is poured into the irrigation tray 26, it seeps through the holes 28 and trickles down to the growing medium 36, orchid 46 and roots 48. Excess water that is not absorbed by the growing medium 36, drips off the orchid 46 and roots 48 and is captured by the humidity tray 22.

The roots 48 benefit from a humid environment as a result of the humidity tray 22 and the moisture trapped within the growing medium 36 while avoiding the risk of rotting due to over watering, inherent in situations when the roots are contained in a pot. The roots 48 are exposed to the air and thrive in an environment that is at once humid and avoids the risk of being too moist.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A vertical planter system for growing epiphytic plants, the system comprising:
a support structure having a frame, wherein the frame includes at least one supporting member for mounting a growing medium to the at least one supporting member;
a base defining a generally flat and shallow cavity for housing humidifying means;
a top end, positioned distal to the base, the top end of the frame further defining a generally elongated cavity for receiving irrigation means; and
means for securing the epiphytic plant to the growing medium.

2. The vertical planter system of claim 1 wherein the supporting member is a vertical supporting member and generally perpendicular to the base.

3. The vertical planter system of claim 1 wherein the supporting member is a horizontal supporting member and generally parallel to the base.

4. The vertical planter system of claim 1 wherein the supporting member is generally diagonal to the base.

5. The vertical planter system of claim 1 wherein the irrigation means is a receptacle having a plurality of apertures positioned on a bottom surface of the receptacle.

6. The vertical planter system of claim 1 wherein the humidifying means includes a receptacle having an evaporative surface at the bottom of the receptacle.

7. The vertical planter system of claim 1, wherein the growing medium is mounted to the at least one supporting member using a thumb tack.

8. The vertical planter system of claim 1, wherein the epiphytic plant is secured to the growing medium using a chord.

9. The vertical planter system of claim 5 wherein the receptacle is dimensioned relative to the growing medium for capturing excess water not absorbed by the growing medium or retained by the epiphytic plant.

10. The vertical planter system of claim 6 wherein the humidifying means comprises a receptacle containing a plurality of rocks.

11. A method of growing epiphytic plants, the method comprising the steps of:
(a) providing a vertical planter system for growing epiphytic plants, the system comprising; a support structure having a frame, wherein the frame includes at least one supporting member for mounting a growing medium to the at least one supporting member; a base defining a generally flat and shallow cavity for housing humidifying means; a top end, positioned distal to the base, the top end of the frame further defining a generally elongated cavity for receiving irrigation means; and means for securing the epiphytic plant to the growing medium;
(b) introducing water from a water supply source to the irrigation means;
(c) allowing water from the irrigation means to trickle on to the growing medium and epiphytic plant; and
(d) capturing excess water not absorbed by the growing medium or epiphytic plant in the humidifying means.

12. The method of claim 11 wherein the at least one support member of the vertical planter system is vertical and generally perpendicular to the base.

13. The method of claim 11 wherein the at least one support member of the vertical planter system is horizontal and generally parallel to the base.

14. The method of claim 11 wherein the at least one support member of the vertical planter system is generally diagonal to the base.

15. The method of claim 11 wherein the irrigation means is a receptacle having a plurality of apertures positioned on a bottom surface of the receptacle.

16. The method of claim 11 wherein the humidifying means includes a receptacle having an evaporative surface at the bottom of the receptacle.

17. The method of claim 11 wherein the humidifying means comprises a receptacle containing a plurality of rocks.

18. The method of claim 11 wherein the receptacle is dimensioned relative to the growing medium for capturing excess water not absorbed by the growing medium or retained by the epiphytic plant.

19. The method of claim 11 wherein the growing medium is mounted to the at least one supporting member using a thumb tack.

20. The method of claim 11 wherein the epiphytic plant is secured to the growing medium using a chord.
